(19) United States
(12) Patent Application Publication
(10) Pub. No.: US 2019/0256743 A1
(43) Pub. Date: Aug. 22, 2019

(54) Pressure Sensitive Adhesives Including (Meth)Acrylates and Rubber

(71) Applicants: Jeffrey R. Bowers, Lock Haven, PA (US); Qiang Luo, State College, PA (US); Yuhua Tong, State College, PA (US)

(72) Inventors: Jeffrey R. Bowers, Lock Haven, PA (US); Qiang Luo, State College, PA (US); Yuhua Tong, State College, PA (US)

(21) Appl. No.: 16/162,744

(22) Filed: Oct. 17, 2018

Related U.S. Application Data
(60) Provisional application No. 62/573,210, filed on Oct. 17, 2017.

(51) Int. Cl. C09J 4/06; C09J 7/38

(52) U.S. Cl. CPC C09J 4/06; C09J 7/385; C09J 7/383

(57) ABSTRACT

Pressure sensitive adhesives are described which comprise a composition of (i) one or more rubber components, (ii) one or more (meth)acrylate monomer(s), and (iii) free radical initiators. In some aspects, the rubber component is selected from the group consisting of ethylene propylene diene monomer (EPDM) rubber, polyisobutylene rubber, farnesene compound, and combinations thereof. Also described are articles including the pressure sensitive adhesives and methods of forming the pressure sensitive adhesives.

### CROSS-REFERENCE TO RELATED APPLICATIONS

This application claims the benefit of U.S. Provisional Application No. 62/573,210, filed Oct. 17, 2017, the entirety of the disclosure of which is incorporated herein by reference.

### FIELD

The present subject matter relates to pressure sensitive adhesives prepared by grafting (meth)acrylate polymer with rubber, particularly ethylene propylene diene monomer (EPDM) rubber. The present subject matter also relates to methods of forming the pressure sensitive adhesives and to articles utilizing the pressure sensitive adhesives.

### BACKGROUND

Pressure sensitive adhesives (PSAs) blended with rubber agents can bond a variety of materials such as glass, metals, painted surfaces, plastics, and the like. Various efforts have been described in which artisans have mixed one or more rubbers and/or rubber-containing agents with a PSA to modify the resulting properties of the PSA. Although satisfactory in certain respects, the resulting PSAs have limited utility due to certain drawbacks attributed to the rubber agents, e.g., lack of adhesion or insufficient tack.

Many PSAs including rubber agents lack sufficient adhesion and tack to adequately adhere to certain low surface energy (LSE) substrates, e.g., polypropylene or polyethylene. As a result, tackifiers are often incorporated into a PSA to increase resulting tack and enable adhesion to certain LSEs. However, many tackifiers have relatively high glass transition temperatures (TGs) that limit application of the resulting tackified PSA for low temperature applications. Accordingly, a class of PSAs including rubbers and/or rubber-containing agents is needed which exhibit good adhesion and tack to a variety of substrates, such as LSEs, at relatively low temperatures.

### SUMMARY

The difficulties and drawbacks associated with previous approaches are addressed in the present subject matter as follows.

In some embodiments, the present subject matter provides a pressure sensitive adhesive composition comprising, consisting essentially of, or consisting of (i) at least one rubber component in an amount ranging from about 1 wt % to about 50 wt %, (ii) at least one (meth)acrylate monomer in an amount ranging from about 5 wt % to about 90 wt %, and (iii) at least one initiator in an amount ranging from about 0.01 wt % to about 1 wt %; wherein the at least one rubber component is selected from the group consisting of ethylene propylene diene monomer (EPDM) rubber, polyisobutylene rubber, farnesene compound, and combinations thereof. In some aspects, the pressure sensitive adhesive is free of tackifier. In some aspects, the at least one initiator is selected from the group consisting of a photo-initiator, a thermal initiator, a radical initiator, a free-radical initiator, and combinations thereof. In some aspects, the at least one rubber component comprises EPDM rubber, wherein the EPDM rubber is amorphous or non-crystalline. In some aspects, the EPDM rubber comprises ethylene in an amount ranging from about 20 wt % to about 70 wt %. In some aspects, the EPDM rubber comprises ethylene in an amount ranging from about 45 wt % to about 70 wt %, wherein the EPDM rubber has a viscosity ranging from 10 Mooney Units to 55 Mooney Units, wherein the EPDM rubber has a glass transition temperature ranging from about −40° C. to about −60° C. In some aspects, the EPDM rubber comprises a non-conjugated diene is selected from the group consisting of ethylidene norbornene, 1-4-hexadiene or dicyclopentadiene, alkyldicyclopentadiene, 1,4-pentadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and combinations thereof. In some aspects, the at least one (meth)acrylate monomer is selected from the group consisting of C1 to C28 alkyl (meth)acrylate, aryl (meth)acrylate, cyclic (meth)acrylate, and combinations thereof. In some aspects, the pressure sensitive adhesive composition comprises the at least one rubber component in an amount ranging from about 5 wt % to about 20 wt %, the at least one (meth)acrylate monomer in an amount ranging from about 5 wt % to about 80 wt %, and the at least one initiator in an amount ranging from about 0.05 wt % to about 0.5 wt %.

In the some embodiments, the present subject matter provides an article including: a substrate; a pressure sensitive adhesive disposed on the substrate, the pressure sensitive adhesive comprising, consisting essentially of, or consisting of (i) at least one rubber component, (ii) at least one (meth)acrylate monomer, and (iii) at least one initiator; wherein the at least one rubber component is selected from the group consisting of ethylene propylene diene monomer (EPDM) rubber, polyisobutylene rubber, farnesene compound, and combinations thereof. In some aspects, the pressure sensitive adhesive is free of tackifier. In some aspects, the substrate comprises paper, polymeric films, and combinations thereof. In some aspects, the pressure sensitive adhesive is in the form of a layer and has a thickness ranging from about 10 to about 125 microns. In some aspects, the pressure sensitive adhesive is disposed on the substrate at a coat weight ranging from about 10 to about 50 gsm. In some aspects, the article is in the form of an adhesive tape. In some aspects, the article further comprises a release liner at least partially disposed on the pressure sensitive adhesive.

In some embodiments, the present subject matter provides a method of forming a pressure sensitive adhesive comprising combining (i) at least one rubber component, (ii) at least one (meth)acrylate monomer, (iii) at least one initiator in a liquid in a reactor; heating the reactor to a temperature ranging from about 25° C. to about 110° C. for a time period sufficient to form a polymeric product; and forming the pressure sensitive adhesive, wherein the forming step comprises: removing the liquid to thereby form the pressure sensitive adhesive; or curing the polymeric product to thereby form the pressure sensitive adhesive; wherein the at least one rubber component is selected from the group consisting of ethylene propylene diene monomer (EPDM) rubber, polyisobutylene rubber, farnesene compound, and combinations thereof. In some aspects, the liquid comprises water, a hydrocarbon, or combinations thereof. In some aspects, heating is performed in an inert atmosphere, wherein heating is performed to a temperature ranging from about 70° C. to about 90° C. In some aspects, the forming step comprises removing the liquid to thereby form the pressure sensitive adhesive, wherein the method further comprises forming a layer of the polymeric product prior to curing.

Before turning attention to the details of the present subject matter and the numerous aspects thereof, it is instructive to consider several terms and their definitions as used herein.

The term “(meth)acrylate” used herein, refers to either an acrylate or a methacrylate. For example, the term “alkyl (meth)acrylates” refers to the group of chemicals that includes both alkyl acrylates and alkyl methacrylates.

(Meth)acrylate-based PSA, as the term is used herein, refers to permanently tacky polymeric compositions comprising acrylate, methacrylate or any combination of such monomers wherein the monomer, an ester of acrylic acid or methacrylic acid, is polymerized or copolymerized with various comonomers containing a polymerizable ethylenic linkage. The polymer is formed via chain growth polymerization techniques. The (meth)acrylate polymers in pressure sensitive adhesives could be homopolymers, i.e. consisting of the same acrylic monomer to make up the polymer chain. Alternatively, the acrylate polymers can be copolymers, i.e. consisting of two or more different monomers placed in a polymer chain. These polymers consist of linear or branched chains. These polymers are cast on to filmic or foil carriers to form PSA tapes. In practice, most often the polymers also undergo slight crosslinking reaction(s) on the web to improve the polymer's internal strength. Crosslinking is facilitated by introducing reactive groups known in the art. The crosslinking of the polymer can be activated by either of the following triggers such as, heat, moisture, ultraviolet, and/or electron beam.

The term ‘room temperature’ used herein, refers to temperatures within the range of from about 15° to about 25° C.

The term ‘acrylic polymer’ used herein, refers to polymers formed from monomers of acrylates and/or methacrylates or any combination of these in a polymer composition wherein the monomers are esters of acrylic acid or methacrylic acid containing a polymerizable ethylenic linkage. This term also includes other classes of monomers with ethylenic linkage that can copolymerize with acrylate and methacrylate monomers.

The term, “curing” used herein, refers to increasing the modulus of the PSA. In some aspects, the curing process includes cross-linking of the PSA.

The terms ‘crosslink’ or ‘crosslinking’ used herein, refer to a process of forming chemical bonds that link one polymer chain to another polymer chain at one or more than one point along the chain. Crosslinking may be achieved with or without the use of an external crosslinking agent(s).

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of an article having a layer or region of a PSA in accordance with some embodiments of the present subject matter.

FIG. 2 is a schematic cross sectional view of the article depicted in FIG. 1 with a protective liner covering the layer of PSA in accordance with some embodiments of the present subject matter.

### DETAILED DESCRIPTION OF THE EMBODIMENTS

The present subject matter provides a pressure sensitive adhesive (PSA) composition comprising a copolymer formed by reacting (i) at least one rubber component, (ii) at least one (meth)acrylate monomer, and (iii) at least one initiator, e.g., free radical initiator. In some embodiments, the polymeric product of the PSA is formed by adding components (i), (ii), and (iii) in a liquid medium to a reactor and subjecting the reaction mixture to reaction conditions described herein. In certain embodiments, the resulting polymeric product is subjected to one or more liquid or solvent removal operations to obtain the PSA. In certain embodiments, it may not be necessary perform one or more liquid and/or solvent removal operations. For example, for some processes which utilize curing, e.g., UV curing, on a web, it may not be necessary to perform liquid or solvent removal. Additionally, liquid or solvent removal may not be necessary for processes employing bulk polymerization followed by UV curing on web. The present subject matter also provides methods of forming the PSAs and articles that include one or more layer(s) or region(s) of the PSAs.

### Reaction Products

As noted, the PSAs comprise copolymers formed by reacting (i) at least one rubber component, (ii) at least one (meth)acrylate monomer, and (iii) at least one initiator. In some embodiments, the PSAs comprise one or more reaction product(s) of (i) at least one rubber component, (ii) at least one (meth)acrylate monomer, and (iii) at least one initiator.

Although a wide array of proportions can be used for components (i), (ii), and (iii), exemplary weight proportions are noted below in Table 1. The proportions are based upon the total weight of (i), (ii), and (iii).

In some embodiments, the PSAs may comprise at least one rubber component in an amount ranging from about 1 wt % to about 50 wt %, based on the total weight of the PSA, e.g., from about 2 wt % to about 45 wt %, from about 3 wt % to about 40 wt %, from about 4 wt % to about 30 wt %, from about 5 wt % to about 20 wt %, from about 6 wt % to about 15 wt %, or from about 8 wt % to about 12 wt %. In terms of upper limits, the PSAs may comprise less than about 50 wt % of at least one rubber component, e.g., less than about 45 wt %, less than about 40 wt %, less than about 35 wt %, less than about 30 wt %, less than about 25 wt %, or less than about 20 wt %. In terms of lower limits, the PSAs may comprise greater than about 1 wt % of at least one rubber component, e.g., greater than about 2 wt %, greater than about 3 wt %, greater than about 4 wt %, greater than about 5 wt %, greater than about 6 wt %, or greater than about 8 wt %.

In some embodiments, the PSAs may comprise at least one (meth)acrylate monomer in an amount ranging from about 5 wt % to about 90 wt %, based on the total weight of the PSA, e.g., from about 10 wt % to about 85 wt %, from about 15 wt % to about 75 wt %, from about 20 wt % to about 70 wt %, from about 25 wt % to about 65 wt %, from about 30 wt % to about 60 wt %, or from about 35 wt % to about 55 wt %. In terms of upper limits, the PSAs may comprise less than about 90 wt % of at least one (meth)acrylate monomer, e.g., less than about 85 wt %, less than about 80 wt %, less than about 75 wt %, less than about 70 wt %, less than about 65 wt %, or less than about 60 wt %. In terms of lower limits, the PSAs may comprise greater than about 5 wt % of at least one (meth)acrylate monomer, e.g., greater than about 10 wt %, greater than about 15 wt %, greater than about 20 wt %, greater than about 25 wt %, greater than about 30 wt %, or greater than 35 wt %.

In some embodiments, the PSAs comprise at least one initiator in an amount ranging from about 0.01 wt % to about 1.0 wt %, based on the total weight of the PSA, e.g., from about 0.02 wt % to about 0.9 wt %, from about 0.04 wt % to about 0.8 wt %, from about 0.06 wt % to about 0.7 wt %, from about 0.08 wt % to about 0.6 wt %, from about 0.1 wt % to about 0.5 wt %, or from about 0.2 wt % to about 0.4 wt %. In terms of upper limits, the PSAs may comprise less than about 1.0 wt % of at least one initiator, e.g., less than about 0.9 wt %, less than about 0.8 wt %, less than about 0.7 wt %, less than about 0.6 wt %, less than about 0.5 wt %, or less than about 0.4 wt %. In terms of lower limits, the PSAs may comprise greater than about 0.01 wt % of at least one initiator, e.g., greater than about 0.02 wt %, greater than about 0.04 wt %, greater than about 0.06 wt %, greater than about 0.08 wt %, greater than about 0.1 wt %, or greater than about 0.2 wt %.

Table 1 provides an exemplary list of the weight percentage of components (i), (ii), and (iii) that form the reaction product.

TABLE 1
Exemplary Portions of Components for Forming
Reaction Products

| | Embodiment 1 | Embodiment 2 |
|---|---|---|
| Component | Wt % | Wt % |
| Rubber Component(s) | 1-50% | 5-20% |
| (Meth)acrylate Monomer(s) | 5-90% | 5-80% |
| Free Radical Initiator(s) | 0.01-1.0% | 0.05-0.5% |

### Rubber Component(s)

A wide array of rubber components can potentially be used in the present subject matter. A representative, nonlimiting listing of such rubbers include natural or isoprene rubber, polyisobutylene rubber, EPDM rubber, nitrile rubber (NBR), styrene butadiene rubber (SBR), silicone rubber, butyl rubber, and polybutadiene. In some embodiments, the rubbers may comprise one or more of EPDM rubber and polyisobutylene rubber. In some embodiments, combinations of these components can be used.

As noted, in many embodiments of the present subject matter, one or more EPDM rubber(s) are used. It is also contemplated that in certain embodiments, the rubber component can include polyisobutylene.

In some embodiments, the EPDM rubbers may comprise ethylene in an amount ranging from about 20 wt % to about 70 wt %, based on the total weight of the EPDM rubber, e.g., from about 25 wt % to about 65 wt %, from about 30 wt % to about 60 wt %, from about 35 wt % to about 55 wt %, from about 40 wt % to about 50 wt %, from about 45 wt % to about 55 wt %, or from about 45 wt % to about 70 wt %. In terms of upper limits, the EPDM rubbers may comprise less than about 70 wt % of ethylene, e.g., less than about 65 wt %, less than about 60 wt %, less than about 55 wt %, less than about 50 wt %, less than about 45 wt %, or less than about 40 wt %. In terms of lower limits, the EPDM rubbers may comprise greater than about 20 wt % of ethylene, e.g., greater than about 25 wt %, greater than about 30 wt %, greater than about 35 wt %, greater than about 40 wt %, greater than about 45 wt %, or greater than about 50 wt %.

In some embodiments, the EPDM rubbers have a glass transition temperature (T_{G}) ranging from about −40° C. to about −60° C., e.g., from about −45° C. to about −55° C. or from about −50° C. to about −60° C. In terms of upper limits, the EPDM rubbers have a glass transition temperature less than about −60° C., e.g., less than about −58° C., less than about −56° C. wt %, or less than about −55° C. In terms of lower limits, the EPDM rubbers have a glass transition temperature greater than about −40° C., e.g., greater than about −42° C., greater than about −44° C. wt %, or greater than about −45° C.

In some embodiments, the EPDM rubbers suitable for use in the present subject matter generally have a relatively low ethylene content of from about 45 percent to about 70 percent by weight, a polymer viscosity of about 10 to about 55 Mooney units (ML/4 at 125° C.) and a relatively low glass transition temperature (Tg) of from about −40° C. to about −60° C., and more preferably from about −45° C. to about −55° C.

Further, in some embodiments, the diene monomer utilized in forming the EPDM rubber (also referred herein as “EPDM terpolymer”) may be a non-conjugated diene. The diene component of the EPDM terpolymer can be any of those commercially available, including but not limited to ethylidene norbornene, 1-4-hexadiene or dicyclopentadiene. Other illustrative examples of non-conjugated dienes which may be employed are alkyldicyclopentadiene, 1,4-pentadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene and the like. In some embodiments, the non-conjugated diene component of the terpolymer may comprise ethylidene norbornene, 5-ethylidene-2-norbornene, or dicyclopentadiene. Moreover, in some embodiments, the EPDM rubbers have from about 2 to about 10 percent by weight unsaturation. The EPDM rubbers may also have a specific gravity of about 0.86 at 23° C.

In some embodiments, the EPDM rubbers have an unsaturation ranging from about 1 wt % to about 20 wt %, e.g., from about 2 wt % to about 18 wt %, from about 4 wt % to about 16 wt %, from about 6 wt % to about 14 wt %, from about 8 wt % to about 12 wt %, or from about 2 wt % to about 10 wt %. In terms of upper limits, the EPDM rubbers have an unsaturation less than about 20 wt %, e.g., less than about 18 wt %, less than about 16 wt %, less than about 14 wt %, less than about 12 wt %, or less than about 10 wt %. In terms of lower limits, the EPDM rubbers have an unsaturation greater than about 1 wt %, e.g., greater than about 2 wt %, greater than about 3 wt %, greater than about 4 wt %, greater than about 5 wt %, or greater than about 6 wt %.

Although any EPDM rubber can be used in the noted subject matter, in some embodiments, the EPDM rubbers can be amorphous or non-crystalline so as to provide for improved processability, especially during extrusion if adhesive tape(s) are formed. Amorphous EPDM rubbers are also considered to have more surface tack than crystalline EPDM rubbers. Generally, some amorphous EPDM rubbers include those EPDM's having less than two percent by weight crystallinity as determined by differential scanning calorimetry (DSC) or dynamic mechanical analysis (DMA) techniques. In some instances, blends of major amounts of amorphous EPDM rubbers and minor amounts of crystalline EPDM rubbers may be used and may be preferred in the present subject matter.

In some embodiments, the crystallinity of the EPDM rubber ranges from 0% to about 70%, e.g., from about 5% to about 65%, from about 10% to about 60%, from about 15% to about 55%, from about 20% to about 50%, from about 25% to about 45%, or from about 30% to about 40%. In terms of upper limits, the crystallinity of the EPDM rubber is less than about 70%, e.g., less than about 65%, less than about 60%, less than about 55%, less than about 50%, less than about 45%, less than about 40%, or less than about 35%. In terms of lower limits, the crystallinity of the EPDM rubber is greater than 0%, e.g., greater than 0%, greater than about 1%, greater than about 5%, greater than about 10%, greater than about 15%, greater than about 20%, or greater than about 25%.

In some embodiments, the EPDM rubbers are commercially available from DSM Copolymer or Baton Rouge, La. under the trademark Keltan®; Exxon Chemical Company of Houston, Tex. under the trademark Vistalone; Uniroyal Chemical Company of Naugatuck, Conn. under the trademark Royalene®; Miles Inc. (Polysar Rubber Division) under the trademark Polysar EPDM®; and E. 1. DuPont de Nemours of Wilmington, Del. under the trademark Nordel®. In addition, EPDM rubbers available from Lion Elastomers under the designation Trilene may be used. Specific non-limiting examples of EPDM rubbers include Trilene CP80, Trilene CP 1100, Trilene T65, Royalene 512, Royalene 509, Royalene 580HT, Keltan 5260C, Keltan 6160D, Nordel IP 3640, IP 3720IP, IP 3745P, IP 3760P, and IP4520.

In some embodiments, the rubber component may comprise polyisobutylene. Non-limiting examples of polyisobutylene which could potentially be used include TPC 595 from TPC Group.

In addition to, or instead of, any of the noted rubber components described herein, one or more farnesene compounds can be utilized as a rubber component in the present subject matter. The term “farnesene” as used herein, refers to a set of six closely related chemical compounds which all are sesquiterpenes. α-Farnesene and β-farnesene are isomers, differing by the location of one double bond. α-Farnesene is 3,7,11-trimethyl-1,3,6,10-dodecatetraene and β-farnesene is 7,11-dimethyl-3-methylene-1,6,10-dodecatriene. The alpha form can exist as four stereoisomers that differ about the geometry of two of its three internal double bonds (the stereoisomers of the third internal double bond are identical). The beta isomer exists as two stereoisomers about the geometry of its central double bond.

### (Meth)Acrylate Monomer(s)

A wide array of (meth)acrylate monomer(s) can be used in the present subject matter. Non-limiting examples of such (meth)acrylate monomers include acrylates, methacrylates, or mixtures thereof. The acrylates may include C1 to about C28 alkyl, aryl or cyclic acrylates such as methyl acrylate, ethyl acrylate, phenyl acrylate, butyl acrylate, 2-ethylhexyl acrylate, n-hexyl acrylate, n-heptyl acrylate, n-octyl acrylate, n-nonyl acrylate, isobornyl acrylate, 2-propyl heptyl acrylate, isodecyl acrylate, isostearyl acrylate and the like. In some embodiments, the acrylates may include from about 3 to about 28 carbon atoms, e.g., from about 3 carbons to about 20 carbons, or from 3 carbons to about 8 carbon atoms.

In some embodiments, the methacrylates include C1 to about C28 alkyl, aryl or cyclic methacrylates such as methyl methacrylate, ethyl methacrylate, butyl methacrylate, 2-ethylhexyl methacrylate, phenyl methacrylate, acetoacetoxyethyl methacrylate, isobornyl methacrylate, isooctyl methacrylate, and the like. In some embodiments, exemplary methacrylates include isooctyl acrylate (IOA), 2-octyl acrylate (2-OA), 2-ethylhexyl acrylate (2-EHA), butyl acrylate (BA), isobornyl acrylate (IBA), and combinations thereof. In some embodiments, the acrylic copolymer utilized in the PSA comprises at least two of such alkyl methacrylates. In some embodiments, the methacrylates may include from about 3 to about 28 carbon atoms, e.g., from about 3 carbons to about 20 carbons, or from 3 carbons to about 8 carbon atoms.

### Initiator(s)

A wide array of initiator(s) can be used. In some embodiments, the initiator is selected from the group consisting of a photo-initiator, a thermal initiator, a radical initiator, a free-radical initiator, and combinations thereof. In some aspects, the initiator is a free-radical initiator. Non-limiting examples include an azonitrile agent, a peroxide agent, an ionic agent, and combinations thereof. An example of an ionic agent is aluminum acetyl acetonate (AAA).

In some embodiments, the initiator serves to catalyze or promote a polymerization reaction of the polymerizable adhesive components. The initiator can comprise a thermal initiator, an oxidative initiator or drier, a photoinitiator, or a combination of any of the foregoing initiators. The thermal initiator is normally activated by heating it above ambient temperature from about 30° to about 200° C. to form free radicals, which initiates free radical polymerization. The thermal initiator can include, for example, organic peroxides and organic azo compounds. The oxidative initiator or drier catalyzes or promotes air oxidation and cross-linking of unsaturates at ambient or elevated temperatures. The oxidative initiator can include for example metal salts and carbodiimides. The photoinitiator comprises a free radical photoinitiator, a cationic photoinitiator, or a combination thereof.

In some embodiments, initiator comprises a photoinitiator, a free radical photoinitiator, or a combination of a free radical initiator and a cationic photoinitiator. Photoinitiators are generally activated by exposure to electromagnetic radiation including infrared, visible, ultraviolet (or UV), and combinations thereof. In some embodiments, the initiator is a UV-activated photoinitiator, a UV-activated free radical photoinitiator, or a combination of UV-activated free radical and cationic photoinitiators. Free radical photoinitiators can be activated by exposure to electromagnetic radiation including, for example, UV to form free radicals which initiate free radical polymerization of unsaturates such as (meth)acrylate-containing resins. Cationic photoinitiators can be activated by exposure to electromagnetic radiation including, for example, UV to form cations which initiate cationic catalyzed type polymerizations such as an epoxide polymerization. The UV-activated free radical photoinitiator can comprise at least one photoinitiator of the type that undergoes a unimolecular bond cleavage reaction to form free radicals including where the cleavage is alpha-cleavage or beta-cleavage, at least one photoiniator and one coinitiator of the type that undergoes a bimolecular bond cleavage reaction to form free radicals, or combinations thereof. Free radical photoinitiators of the unimolecular bond cleavage type can comprise benzoyl type photoinitiators including benzoin ethers and benzil ketals and alpha-dialkoxyacetophenones and alpha-hydroxyalkylphenones and alpha-halogeno-acetophenones, amino-ketones, acyl-phosphine oxides, or mixtures thereof.

In some embodiments, useful unimolecular type free radical photoinitiators include, for example, 2-hydroxy-2-methylpropiophenone and/or butyrophenone and the commercial UV-activated free radical photoinitiators SARCURE®SR1135 from Sartomer Company, Inc. which is a three-photoinitiator-blend of 2,4,6-trimethyl benzoyl diphenyl phosphine oxide and oligo [2-hydroxy-2-methyl-1-[4-(1-methylvinyl)phenyl]propanone] and methylbenzophenone derivatives, Genocure® LTM from Rahn Corp, the 1-hydroxycyclohexyl phenyl ketone based photoinitiator Esacure® KS300 from Sartomer, the oligomeric photoinitiator oligo [2-hydroxy-2-methyl-1-[4-(1-methylvinyl)phenyl]propanone] from Sartomer, the photoinitiators KIP 150 and KIP 100F and KL 200 from Lamberti, and the 4-phenylbenzophenone based photoinitiator Genocure® PBZ from Rahn. Free radical photoinitiators of the bimolecular bond cleavage type can comprise as the photoinitiator at least one of a benzophenone or a thioxanthone or a titanocene and as the coinitiator at least one of an alcohol or an ether or an amine having an abstractable alpha-hydrogen. Useful bimolecular type free radical photoinitiators and coinitiators include for example benzophenone and tetrahydrofuran. The UV-activated cationic photoinitiator can comprise a photoinitiator of the type comprising a sulfonium salt, an iodonium salt, or mixtures thereof including, for example, the SARCAT® CD 1010, 1011 and 1012 series of photoinitiators available from Sartomer. Selection of a UV-activated photoinitiator and the amount of the photoinitiator is generally based on the emission characteristics and intensity of the UV source and on the spectral sensitivity of the photoinitiator. The commercially available photoinitators can be used individually or in combinations depending on the requirements for an adhesive and service conditions. Generally, oligomeric photoinitiators are used in adhesive applications involving high temperatures and/or extended times at temperatures above ambient.

In some embodiments, the adhesive comprises a free radical photoinitiator, such as for example a UV-activated free radical photoinitiator, wherein the adhesive can be cured by being exposed for less than 5 minutes, or 3 minutes, or 1 minute to an electromagnetic radiation source, such as for example a UV source, having an intensity of at least 20, or 50, or 80, or 100 mJ/cm² (millijoules per square centimeter) where the (meth)acrylate resin double bonds of the adhesive are at least 60%, or 70%, or 80%, or 90% reacted or consumed.

### Liquid Medium

One or more liquids and/or solvents may optionally be included in the reaction mixture. Typically, the one or more liquids and/or solvents are added prior to reacting the components (i), (ii), and (iii), but the present subject matter includes the addition of liquid(s) and/or solvent(s) during and after reaction.

Non-limiting examples of suitable liquids and/or solvents is selected from water, one or more hydrocarbons compounds, one or more hydrocarbon solvents, and combinations thereof. In some embodiments, the solvents may include toluene, hexane, ethyl acetate, xylene, methanol, acetone, heptane, isopropanol, butanol, chloroforms, dimethyl sulfoxide, and combinations thereof.

In some embodiments, hydrocarbon compounds can include, but are not limited to, oligomers and hydrocarbon polymers. Such hydrocarbon compounds can be any fully hydrogenated (but can range in hydrogenation from 0% to 100%) polymer compatible with the hydrocarbon macromers and preferably having a molecular weight of equal to or greater than 1,000 g/mole or equal to or less than 1000 g/mole. In additional embodiments, hydrocarbon oligomers and hydrocarbon polymers that can be used to add to the hydrocarbon phase of the PSA can be crystalline in nature, and/or further contain reactive sites. The reaction sites can consist of, but are not limited to, silyl, carboxylic acid, hydroxyl, anhydride, aldehyde, ketone, acetate, acetoacetyl, isocyanato, amine, amide, imide, aziridine, epoxide, mercapto, (meth)acrylate, vinyl, and mixtures thereof. Illustrative, non-limiting examples of such hydrocarbon oligomers and hydrocarbon polymers include, but are not limited to, ethylene, propylene, butadiene, isoprene, isobutylene, hexene, octene, the like, and mixtures thereof.

Commercially available examples of hydrocarbon compounds include oligomers and hydrocarbon polymers, such as LIR-200 and LIR-290 manufactured by Kuraray Co., Ltd., and UC203, a methacrylic functionlized liquid isoprene rubber that can be UV light or peroxide cured, also available from Kuraray Co., Ltd.; EXXELOR VA1201, EXXELOR VA1202, EXXELOR VA1801, EXXELOR VA1803, EXXELOR VA1840, EXXELOR VA1850 (maleic anhydride functionalized elastomeric ethylene copolymers), EXXELOR PO 1015, EXXELOR PO 1020 (maleic anhydride functionalized polypropylenes), and EXXELOR PE 1040 (maleic anhydride functionalized polyethylenes) available from ExxonMobil Chemical Corporation of Irving, Tex.; KRATON D series such as KRATON D-1101 K(SBS) and KRATON D-1107 (SIS), KRATON G series, for example, KRATON G-1657M (SEBS) and KRATON G-1730M (SEPS), KRATON FG series such as KRATON FG-1901, KRATON IR, for example, KRATON IR-305 (IR) available from Kraton Polymers LLC of Houston, Tex.; and POLY BD series such as POLY BD 45 CT (carboxyl-terminated polybutadiene), POLY BD 600E (epoxidized hydroxyl terminated polybutadiene resin), POLY BD R4HTLO (hydroxy terminated polybutadiene resin), POLY BD LF-2 (hydroxyl terminated 1, 3-butadiene homopolymer), POLY BD R45VT (vinyl functional polybutadiene) available from Sartomer Company, Inc of Exton, Pa.

Such rubber-acrylic hybrid polymers can be made by copolymerizing the hydrocarbon monomers such as alkyl acrylate ester monomers in the presence of a rubber component containing a reactive acrylic or methacrylic end group and adding selected hydrocarbon compounds having a molecular weight (Mw) of equal to or greater than 1,000 g/mole or equal to or less than 1000 g/mole. Alternatively, an acrylic backbone can be produced with pendant functional groups capable of reacting with the end group of a rubber component not having an acrylic or (meth)acrylic group, for instance, an acrylic backbone with anhydride groups and rubber component containing one terminal hydroxyl group. These additional hydrocarbon compounds may be added via any one of several methods that are known in the art, examples of which include, but are not limited to, solvent blending, hot-melt extrusion, reactive extrusion, or polymerizing in the presence of the additional hydrocarbon compounds.

### Additional Agent(s)

One or more additional agent(s) can be added to the reaction mixture including the previously noted (i) at least one rubber component, (ii) at least one (meth)acrylate monomer, and (iii) at least one initiator. Non-limiting examples of such additional agents include surfactant and/or conventional additives.

### Methods

In some embodiments, the methods of the present subject matter comprise one or more operations of combining (i) at least one rubber component, (ii) at least one (meth)acrylate monomer, and (iii) at least one initiator. Typically, the components (i), (ii), and (iii) are combined in a liquid as noted herein. The components can be combined in the proportions noted herein. The components are administered into a suitable vessel such as a reactor. The methods also comprise heating the reactor and/or the components (i), (ii), and (iii) to a temperature ranging from about 25° C. to about 110° C., and in particular embodiments from about 70° C. to about 90° C. for a time period sufficient to form a polymeric reaction product. In some embodiments, in order to obtain a PSA, the liquid is removed. In many embodiments, the reaction is performed in an inert atmosphere such as an inert gas, e.g., N₂.

To ensure that the polymeric reaction product described herein exhibits pressure sensitive adhesive properties, the chemical composition of the final polymer conforms to the rules of Dahlquist criteria and glass transition temperature requirements for pressure sensitive materials, which are known in this field of art. According to what has come to be known as the Dahlquist criteria, to perform as a pressure sensitive adhesive, the formulation must have a plateau shear modulus at 25° C. and 1 radian per second that is between 5×10⁴ and 6×10⁶ dynes/cm² as determined by dynamic mechanical analysis. A material having plateau shear modulus greater than 1×10⁷ dynes/cm² at 25° C. will be too stiff to exhibit tack at room temperature to be useful as pressure sensitive adhesive. A material with plateau shear modulus less than 1×10⁴ dynes/cm² at 25° C. will lack sufficient cohesive strength to be useful as pressure sensitive adhesive. Representative and non-limiting examples of ranges of the dynamic mechanical analysis (DMA) measured glass transition temperatures (Tg) for the pressure sensitive adhesives of the instant subject matter are from about −75° C. to about 107° C., or from about −50° C. to about 25° C., −40° C. to about 0° C., and/or from about −10° C. to about −40° C.

In some embodiments, the PSAs formed in accordance with the present subject matter methods have a weight average molecular weight (Mw) ranging from about 100,000 to about 1,000,000 g/mole, e.g., from about 120,000 to about 550,000 g/mole, from about 140,000 to about 500,000 g/mole, from about 160,000 to about 450,000 g/mole, from about 180,000 to about 425,000 g/mole, from about 200,000 to about 400,000 g/mole, from about 200,000 to about 300,000 g/mole, or from about 225,000 to about 275,000 g/mole. In terms of upper limits, the PSA has an average molecular weight less than about 1,000,000 g/mole, e.g., less than about 600,000, less than about 550,000 g/mole, less than about 500,000 g/mole, less than about 450,000 g/mole, less than about 400,000 g/mole, or less than about 350,000 g/mole. In terms of lower limits, the PSA has an average molecular weight greater than about 100,000 g/mole, e.g., greater than about 120,000 g/mole, greater than about 140,000 g/mole, greater than about 160,000 g/mole, greater than about 180,000 g/mole, greater than about 200,000 g/mole, or greater than about 250,000 g/mole. However, it will be appreciated that the present subject matter polymers may have weight average molecular weights greater than about 1,000,000 and/or less than about 100,000 g/mole. The weight average molecular weight (Mw) was determined by gel permeation chromatography (GPC) using polystyrene standards.

In some embodiments, the PSA can be cross-linked, e.g., form a chemical bond with another polymer, with other polymers to obtain preferred performance characteristics. In some aspects, the PSA can be blended with polymer resins to form a polymer network. For example, the PSA can be cross-linked with well-known polymers, e.g., acrylic resins, to obtain a desired shear value, peel strength, or both.

The percent gel is a measure of the amount of materials that has been cross-linked, and may be represented by a percentage of insoluble portions in the total amount of materials for a given solvent. In some embodiments, the gel content of the PSA may range from about 1% to about 70%, e.g., from about 5% to about 65%, from about 10% to about 60%, from about 15% to about 55%, from about 20% to about 50%, from about 25% to about 45%, or from about 30% to about 40%. In terms of upper limits, the gel content of the PSA is less than about 70%, e.g., less than about 65%, less than about 60%, less than about 55%, less than about 50%, less than about 45%, or less than about 40%. In terms of lower limits, the gel content of the PSA is greater than about 1%, e.g., greater than about 5%, greater than about 10%, greater than about 15%, greater than about 20%, greater than about 25%, or greater than about 30%.

In some embodiments, the method comprises heating the reactor and/or the components (i), (ii), and (iii) to a temperature ranging from about 25° C. to about 110° C., e.g., from about 40° C. to about 105° C., from about 50° C. to about 100° C., from about 60° C. to about 95° C., from about 70° C. to about 90° C., or from about 75° C. to about 85° C. In terms of upper limits, the method comprises heating the reactor and/or the components (i), (ii), and (iii) to a temperature less than about 110° C., e.g., less than about 105° C., less than about 100° C., less than about 95° C., or less than about 90° C. In terms of lower limits, the method comprises heating the reactor and/or the components (i), (ii), and (iii) to a temperature greater than about 25° C., e.g., greater than about 40° C., greater than about 50° C., greater than about 60° C., or greater than about 70° C.

In certain embodiments, water may be used as a liquid medium and/or solvent and included with the reactants prior to and/or during reaction. In other embodiments, one or more hydrocarbon solvent(s) can be used and included with the reactants prior to and/or during the reaction.

Specifically, in one embodiment, acrylic monomers, hydrocarbon rubber, surfactant(s) and water were passed through a homogenizer to reach a targeted particle size. The dispersed material was then charged into a reactor. The mixture was then heated to a temperature ranging from 70° to 90° C. and a free radical initiator was added to begin the reaction. After the peak temperature was reached, monomer feed including water, surfactant and acrylic monomers was fed at a designated rate with co-feed of free radical initiator solution. After both feeds, chase-free-radical solution was added and then held for about 1 hour. The solution was then cooled down and withdrawn from the reactor for further evaluation.

In another embodiment, acrylic monomers, hydrocarbon rubber, surfactant(s) and water were passed through a homogenizer to reach a targeted particle size. The dispersed material was then partially charged into a reactor. The mixture was then heated to a temperature ranging from 70° to 90° C. and a free radical initiator was added to begin the reaction. After the peak temperature was reached, the rest of the homogenized material was fed at a designated rate with a co-feed of free radical initiator solution. After both feeds were charged into the reactor, chase-free-radical solution was added and then held for about 1 hour. The solution was then cooled down and withdrawn from the reactor for further evaluation.

In another embodiment, the initial charge feed including acrylic monomers, hydrocarbon rubber, and solvent was administered into a reactor and purged with N₂. The reactor was then heated to a temperature ranging from 70° to 90° C. and a free radical initiator was charged into the reactor. After the peak temperature was reached, a monomer feed including acrylic monomers, hydrocarbon rubber, and solvent was fed at a designated rate with a co-feed of free radical initiator solution. After both feeds were charged to the reactor, chase-free-radical solution was added and then held for about 1 hour. The solution was then cooled down and withdrawn from the reactor for further evaluation.

In another embodiment, an initial charge including acrylic monomers, hydrocarbon rubber, and solvent was poured into a reactor and purged with nitrogen gas. The reactor was then heated to a temperature ranging from 70° to 90° C. and a free radical initiator was charged into the reactor. After the peak temperature was reached, a monomer feed including acrylic monomers and solvent was fed at a designated rate with a co-feed of free radical initiator solution was charged into the reactor. After both feeds were charged into the reactors, chase-free-radical solution was added and then held for about 1 hour. The solution was then cooled down and withdrawn from the reactor for further evaluation.

And, in another embodiment, an initial charge including acrylic monomers and solvent was poured into a reactor and purged with nitrogen gas. The reactor was then heated to a temperature ranging from 70° to 90° C. and a free radical initiator was charged into the reactor. After the peak temperature was reached, monomer feed including acrylic monomers, hydrocarbon rubber, and solvent were fed at a designated rate with a co-feed of free radical initiator solution into the reactor. After both feeds were charged into the reactor, chase-free-radical solution was added and then held for about 1 hour. The solution was then cooled down and withdrawn from the reactor for further evaluation.

Processing Polymeric Product after Reaction(s) to Form PSA and Properties

After reaction and formation of the reaction product(s), the liquid, e.g., solvent used in the polymerization process, is removed. Removal of the liquid may be performed by any technique that is not detrimental to the PSA. Nonlimiting examples of removal of the liquid include, e.g., evaporation and/or heating. Representative heating temperatures typically range from 70° C. to about 100° C.

The pressure sensitive adhesive can be applied using standard coating techniques, such as, e.g., curtain coating, gravure coating, reverse gravure coating, offset gravure coating, roller coating, brushing, knife-over roll coating, air knife coating metering rod coating, reverse roll coating, doctor knife coating, dipping, die coating, spraying, and the like. The application of these coating techniques are well known in the industry and can effectively be implemented by one skilled in the art. The knowledge and expertise of the manufacturing facility applying the coating determine the preferred method. Further information on coating methods can be found in “Modern Coating and Drying Technology”, by Edward Cohen and Edgar Gutoff, Val Publishers, Inc., 1992.

As previously described herein, in certain embodiments, PSAs of the present subject matter can be prepared without a liquid or solvent removal operation. It will be understood that the present subject matter includes processes for preparing the PSAs with a liquid or solvent removal operation, and processes for preparing the PSAs without a liquid or solvent removal operation. Typically, the processes for preparing PSAs without a liquid or solvent removal operation involve curing the polymeric product produced from the reaction of (i) at least one rubber component, (ii) at least one (meth)acrylate monomer, and (iii) at least one initiator in a liquid. In some aspects, curing the noted polymeric product results in formation of the PSA. As used herein, “curing” refers to increasing the modulus of the PSA. In some aspects, the curing process includes cross-linking of the PSA. The terms ‘crosslink’ or ‘crosslinking’ refer to a process of forming chemical bonds that link one polymer chain to another polymer chain at one or more than one point along the chain. Crosslinking may be achieved with or without the use of an external crosslinking agent(s). The crosslinking of the PSA can be activated by either of the following triggers such as, heat, moisture, ultraviolet, and/or electron beam. In some aspects, the PSA can be formed without any curing process, e.g., without any cross-linking of the PSA.

In many applications prior to curing, the polymeric product is deposited on a web or other surface to form a layer. The resulting layer is then subjected to one or more curing operations to thereby form the PSAs. In some embodiments, curing can be performed by a wide array of techniques including, e.g., curing by exposure to UV light.

### Resulting PSAs

The resulting PSAs exhibit excellent tack and adhesion at temperatures less than 20° C., in certain embodiments less than 10° C., in certain embodiments less than 0° C., in certain embodiments less than −10° C., and in some embodiments less than −20° C.

As previously noted, the resulting PSAs exhibit high levels of adhesion to a variety of LSEs, including polypropylene (PP) and high density polyethylene (HDPE).

In particular embodiments, the resulting PSAs have a glass transition temperature (Tg) within a temperature range of from about −75° C. to about 107° C. In some aspects, the resulting PSAs have a glass transition temperature (Tg) within a temperature range of from about −50° C. to about 25° C.

In certain embodiments, the resulting PSAs are free of tackifier. However, the present subject matter includes the incorporation of one of more tackifiers.

### Crosslinking Agent

The adhesive may be crosslinked during post curing of the adhesive to increase the cohesive strength of the pressure sensitive adhesive. This can be achieved via covalent crosslinking such as heat, actinic or electron beam radiation, or metal based ionic crosslinking between functional groups. Table 1 below lists the types of crosslinkers for the various functional groups of the segmented polymer.

TABLE 1
Possible Crosslinkers for Polymers

| Functional | |
|---|---|
| Group of | |
| Polymer | Crosslinker |
| Silane | Self-reactive |
| Hydroxyl | Isocyanate, Melamine Formaldehyde, Anhydride, Epoxy, |
| | Titanium esters and Chelates |
| Carboxylic | Anhydride, Epoxy, Carboiimides, Metal Chelates, |
| acid, | Titanium esters and Oxazolines |
| phosphoric | |
| acid | |
| Isocyanate, | Self-reactive, Carboxylic acid, Amine, Hydroxyl Addition |
| Vinyl | reaction with Silicone hydride Amine, Mercaptan, Self- |
| (Meth)- | reactive with radical catalyst (UV, Thermal), Acetoacetate |
| acrylate | |
| Epoxy | Amine, Carboxylic acid, Phosphoric acid, Hydroxyl, |
| | Mercaptan |
| Amine | Isocyanate, Melamine formaldehyde, anhydride, epoxy, |
| | acetoacetate |
| Mercapto | Isocyanate, Melamine formaldehyde, Anhydride, Epoxy |
| Acetoacetate | Acrylate, Amine |

### Articles

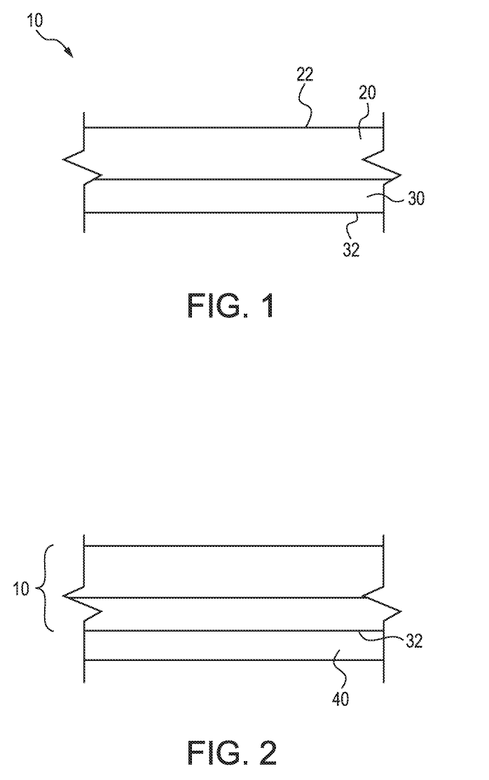

The present subject matter also provides articles that include one or more layer(s) or region(s) of the noted PSAs. FIG. 1 is a schematic cross sectional view of an article 10 comprising a substrate 20 and a layer or region 30 of a PSA as described herein. The substrate 20 may include a second layer or region of the PSA (not shown) disposed on a face 22 of the substrate 20. The layer 30 of the PSA defines an exposed face 32 which is tacky and ready for adherence. FIG. 2 depicts the article 10 further including a protective liner 40 disposed over or on the layer 30 of the PSA, and specifically on the otherwise exposed face 32 of the PSA. As will be appreciated, the liner 40 can be removed to expose the tacky adhesive face 32 of the PSA.

The article can include a substrate, an adhesive layer, and optionally a release liner. The substrate may be a facestock which is useful for decorative or graphic image applications. The facestocks typically have a thickness from about 10 to about 300, or from about 25 to about 125 microns. The facestocks may include paper and/or polymeric films. Non-limiting examples of polymeric films include polyolefins (linear or branched), polyamides, polystyrenes, nylon, polyesters, polyester copolymers, polyurethanes, polysulfones, polyvinylchloride, styrene-maleic anhydride copolymers, styrene-acrylonitrile copolymers, ionomers based on sodium or zinc salts of ethylene methacrylic acid, polymethyl methacrylates, cellulosics, fluoroplastics, acrylic polymers and copolymers, polycarbonates, polyacrylonitriles, and ethylene-vinyl acetate copolymers. Included in this group are acrylates such as ethylene methacrylic acid, ethylene methyl acrylate, ethylene acrylic acid and ethylene ethyl acrylate. Also, included in this group are polymers and copolymers of olefin monomers having, for example, 2 to about 12 carbon atoms, and in one embodiment 2 to about 8 carbon atoms. These include the polymers of alpha-olefins having from 2 to about 4 carbon atoms per molecule. These include polyethylene, polypropylene, poly-1-butene, etc. An example of a copolymer within the above definition is a copolymer of ethylene with 1-butene having from about 1 to about 10 weight percent of the 1-butene comonomer incorporated into the copolymer molecule. The polyethylenes that are useful have various densities including low, medium and high density ranges. The low density range is from about 0.910 to about 0.925 g/cm³; the medium density range is from about 0.925 to about 0.940 g/cm³; and the high density range is from about 0.94 to about 0.965 g/cm³. Films prepared from blends of copolymers or blends of copolymers with homopolymers also are useful. The films may be extruded as a monolayer film or a multi-layered film.

In some embodiments, the pressure sensitive adhesive may have a thickness ranging from about 10 microns to about 125 microns, e.g., from about 15 microns to about 115 microns, from about 20 microns to about 100 microns, from about 25 microns to about 75 microns, or from about 30 microns to about 50 microns. In terms of upper limits, the pressure sensitive adhesive may have a thickness less than about 125 microns, e.g., less than about 110 microns, less than about 100 microns, less than about 90 microns, less than about 80 microns, or less than about 70 microns. In terms of lower limits, the pressure sensitive adhesive may have a thickness greater than about 10 microns, e.g., greater than about 20 microns, greater than about 25 microns, greater than about 30 microns, greater than about 40 microns, or greater than about 50 microns.

In some embodiments, the coat weight of the pressure sensitive adhesive may range from about 10 grams per square meter (gsm) to about 50 gsm, e.g., from about 15 gsm to about 45 gsm, from about 20 gsm to about 40 gsm, from about 20 gsm to about 35 gsm, from about 25 gsm to about 35 gsm, or from about 30 gsm to about 35 gsm. In terms of upper limits, the coat weight of the pressure sensitive adhesive may be less than about 50 gsm, e.g., less than about 45 gsm, less than about 40 gsm, or less than about 35 gsm, or less than about 30 gsm. In terms of lower limits, the coat weight of the pressure sensitive adhesive may be greater than about 10 gsm, e.g., greater than about 15 gsm, greater than about 20 gsm, or greater than about 25 gsm.

Release liners for use in the present subject matter may be those known in the art. In general, useful release liners include polyethylene coated papers with a commercial silicone release coating, polyethylene coated polyethylene terephthalate films with a commercial silicone release coating, or cast polypropylene films that can be embossed with a pattern or patterns while making such films, and thereafter coated with a commercial silicone release coating. In some embodiments, the release liner is kraft paper which has a coating of low density polyethylene on the front side with a silicone release coating and a coating of high density polyethylene on the back side.

Non-limiting examples of adhesive articles using the PSAs include, but are not limited to tapes and particularly industrial, medical and surgical tapes which can be single or dual sided, bandages, dressings, wound coverings, ostomy components including ostomy appliances and stoma components, devices and sensors that are adhered or otherwise contacted with skin.

The pressure sensitive adhesive article of the present subject matter may be used in a wide variety of applications such as adhesive articles for medical use including bandages, surgical drapes, intravenous dressings, wound dressings, and self adhesive wound rolls. Additional applications include industrial, automotive, aerospace, military or consumer use such as floor covering adhesives, shock absorbent adhesive mounts, double sided adhesive articles, self adherent labels, self sealing envelopes, resealable bags, envelopes and containers, single and double faced adhesive tape, weather-stripping, thermal insulation, and sound insulation. The articles will also find use in cold temperature applications.

### EXAMPLES

In the examples, various measurements and assessments were made using procedures as follows.

### Dynamic Mechanical Analysis

Dynamic Mechanical Analysis (DMA) was performed on a TA Instrument AR-2000 rheometer using parallel plate clamps. 1.0 mm thick samples were placed in the clamp and annealed at 50° C. for 10 minutes to ensure good adhesion. The samples were then cooled to −60° C. for 10 minutes and ramped at 3° C. per minute up to 170° C. During the temperature ramp the sample was oscillated at a frequency of 10 rad/s.

### 90 Degree and 180 Degree Peel

Samples of the adhesive either directly coated on PET film or laminated to PET film from a release liner were cut into about 2.5 cm by about 15 cm test strips. The strips were rolled down on a test panel of polypropylene (PP), glass, HDPE, PVC, or other panel type as noted herein with a 2 kg rubber clad steel roller moving back and forth at a rate of about 30 cm/min or as otherwise reported herein. In certain trials, the panels were covered with a flexible liner or “flow-wrap.” After a dwell time of 24 hours, the test strips were peeled away from the test panel in an Instron Tensile Tester at either 90 degrees or 180 degrees to the test panel, i.e., folded back on itself and parallel to the surface of the panel, at a rate of about 30 cm/min. The force to remove the adhesive strip from the test panel was measured in pounds per inch (lb/in). Tests were performed in triplicate and the average value was reported.

### Static Shear

Samples of the adhesive coated on PET film were laminated to a stainless steel (SS) panel using a 2 kg rubber clad steel roller with a free end of the tape extending beyond the plate. The adhesive contact area was 1.27 cm by 1.27 cm or as reported herein. After 20 minutes dwell at room temperature, the plate was placed at a 2° angle from the vertical and a 500 g weight was suspended from the free end. The time to failure in minutes was measured.

### Loop Tack

Loop tack measurements were made for strips having dimensions of about 25 mm (1 inch) wide using stainless steel as the substrate at a draw rate of about 50 cm/min (20 in/min), according to standard test 1994 Tag and Label Manufacturers Institute, Inc. (TLMI) Loop Tack Test L-1B2, using an Instron Universal Tester Model 4501 from Instron (Canton, Mass.). Loop tack values are taken to be the highest measured adhesion value observed during the test. The results, reported in lb/in, are reported where the substrate is stainless steel.

### Mode of Failure (MOF)

In many of the peel evaluations and static shear evaluations, the mode of failure (MOF) is noted. Various designations are used to describe the differing types of failure. These designations and their meanings are as follows. “Clean/no transfer” refers to no visible residue on substrate. “Zippy/cohesive” refers to zippy peel with cohesive failure. “Zippy/no transfer” refers to zippy peel with no visible residue on substrate. “Lt. stain” refers to light stain. “Lt. zip” refers to light zippiness. “Major zip” refers to major zippy peel. “Split/tab slip” refers to adhesive split. “Zip/med. Tr.” refers to zippy peel with medium adhesive transfer from facestock to substrate. “Zip/v. It. tr.” refers to zippy peel with very light transfer from facestock to substrate. “CS. spotty no tr.” Refers to sporadic cohesive failure without transfer from facestock to substrate. “No tr, spotty CS” refers to sporadic cohesive failure without transfer from facestock to substrate. “No tr” refers to without transfer from facestock to substrate. “Mix of CS and No tr” refers to mix failure of cohesive failure and without transfer from facestock to substrate. “Mix of 100% tr, no tr and CS” refers to mix failure modes of completely transfer, no transfer and cohesive failure.

In one trial, an amount of EPDM rubber was combined with (meth)acrylate monomer as described herein with solvents and then heated in a reactor with initiators as described herein. The adhesive compositions were then coated onto 2 mil PET. The resulting 90° peel on a PP panel was about 2.5 lb/inch. 90° peel on a HDPE panel was about 0.9 lb/inch with 10% of EPDM in dry adhesives. Static shear on stainless steel (SS) with 1 inch by 1 inch by 1 kg, was about 1,500 minutes.

In another trial, an EPDM rubber was dissolved in monomer as described herein with water and surfactant. The mixture was then homogenized with ultrasound. The emulsion had an average particle size of approximately 330 nm and was then heated in a reactor with an initiator. The resulting adhesive showed very aggressive tack, e.g., greater than 3 lbf/in in loop tack, on PP and HDPE panels.

In another trial, Samples 1-4 were tested for 901 peel adhesion to PVC panels covered with three variants of Belmark Flow-Wrap, referred to herein as “flow wrap.” The types of flow wrap included (i) a PET Gloss flow wrap or Gloss Flowrap (PET), (ii) a PET Matte flowrap or Matte Flowrap (PET), and (iii) OPP Aluminum flow wrap or A.L. Flowrap (OPP).

Each adhesive composition was coated on naked 2 mil PET using a 0.127 mm jib or a 0.152 mm jib on a conventional drawdown table. The resulting samples were dried in an oven set at 120 IC for 15 min then covered with a 2 mil PET release top sheet. Each drawdown was cut into 1 inch strips and labeled accordingly. The strips were applied to clean flow wrap panels (panel+double-sided tape+flow wrap) and rolled 2 times at 24 in/min with a 5 lb roller. The samples were tested using a MTS system and “90 peel no slack” program as known in the art. Once tested, the samples were rolled again 2 times at 24 in/min with the 5 lb roller.

Table 2 set forth below notes the adhesive coat weights for Samples 1-4. The adhesive compositions were prepared as described herein using 5 wt % to 20 wt % by weight Trilene CP80 as the rubber component, (meth)acrylate monomer as described herein, and varying amounts of crosslinker.

TABLE 2

| Sample | Coat Weight (gsm) |
|---|---|
| 1 | 17.6 |
| 2 | 14.7 |
| 3 | 16.2 |
| 4 | 23.1 |

Table 3 lists crosslinking parameters using aluminum acetoacetate (AAA) for each of Samples 1-4.

TABLE 3

| Sample | Crosslinking Parameters |
|---|---|
| 1 | 0.1-0.5% AAA |
| 2 | 0.1-0.5% AAA |
| 3 | 0.1-0.5% AAA |
| 4 | 0.1-0.5% AAA |

Tables 4-6 summarize the results of 90 degree peel evaluations using the MTS system.

TABLE 4
Results of 90 Degree Peel Evaluations

| | 15 minute Dwell | | ~48 Hour Dwell (PET Gloss) | |
|---|---|---|---|---|
| | (PET Gloss) | | Second Open | |
| Sample | Force | Mode of Failure | Force | Mode of Failure |
| 1 | 0.21 | clean/no transfer | 0.17 | clean/no transfer |
| | 0.26 | clean/no transfer | 0.26 | clean/no transfer |
| 2 | 0.15 | clean/no transfer | 0.11 | clean/no transfer |
| | 0.16 | clean/no transfer | 0.12 | clean/no transfer |
| 3 | 1.34 | clean/no transfer | 1.32 | clean/no transfer |
| | 1.58 | clean/no transfer | 1.61 | clean/no transfer |
| 4 | 1.61 | clean/no transfer | 1.72 | clean/no transfer |
| | 1.53 | clean/no transfer | 1.31 | clean/no transfer |

TABLE 5
Results of 90 Degree Peel Evaluations

| | 15 Minute Dwell | | ~48 Hour Dwell (PET Matte) | |
|---|---|---|---|---|
| | (PET Matte) | | Second Open | |
| Sample | Force | Mode of Failure | Force | Mode of Failure |
| 1 | 1.76 | clean/no transfer | 1.86 | zippy/cohesive |
| | 1.74 | clean/no transfer | 1.91 | zippy/cohesive |
| 2 | 1.54 | clean/no transfer | 1.25 | clean/no transfer |
| | 1.47 | clean/no transfer | 1.28 | clean/no transfer |
| 3 | 1.26 | clean/no transfer | 1.01 | clean/no transfer |
| | 1.38 | clean/no transfer | 1.16 | clean/no transfer |
| 4 | 1.36 | clean/no transfer | 1.35 | clean/no transfer |
| | 1.21 | clean/no transfer | 0.93 | clean/no transfer |

TABLE 6
Results of 90 Degree Peel Evaluation

| | | | ~48 Hour Dwell | |
|---|---|---|---|---|
| | 15 Minute Dwell | | (OPP Aluminum) | |
| | (OPP Aluminum) | | Second Open | |
| Sample | Force | Mode of Failure | Force | Mode of Failure |
| 1 | 0.78 | clean/no transfer | 0.82 | clean/no transfer |
| | 0.89 | clean/no transfer | 0.80 | zippy/no transfer |
| 2 | 0.58 | clean/no transfer | 0.62 | clean/no transfer |
| | 0.64 | clean/no transfer | 0.56 | clean/no transfer |
| 3 | 0.46 | clean/no transfer | 0.32 | clean/no transfer |
| | 0.39 | clean/no transfer | 0.39 | clean/no transfer |
| 4 | 0.46 | clean/no transfer | 0.39 | clean/no transfer |
| | 0.35 | clean/no transfer | 0.31 | clean/no transfer |

In another series of evaluations, three (3) sets of Samples A-L of pressure sensitive adhesive as described herein were prepared. Each adhesive sample was applied at a coat weight (CW) noted below (gsm). Samples A-L comprised varying proportions of EPDM rubber, i.e., 5%, 10%, or 20% Trilene CP80, effective amounts of (meth)acrylate monomer(s), and varying amounts of cross-linker aluminum acetoacetate ranging from 0.1 wt % to 0.5 wt %, based on the total weight of the samples. The (meth)acrylate monomers included 2-ethylhexylacrylate, butylacrylate, acrylic acid, methacrylic et al. One set of adhesive samples were prepared using A.L. Flowrap (OPP) and the results of evaluations are set forth below in Table 7. Another set of adhesive samples were prepared using Matte Flowrap (PET) and the results of evaluations are set forth in Table 8. Another set of adhesive samples were prepared using Gloss Flowrap (PET) and the results of evaluations are set forth below in Table 9.

In the 90 degree peel evaluations of Tables 7-9, the force after 15 minute dwell is noted under the column “15 min” and the mode of failure noted under “MOF.” The average force associated with the 15 minute dwell is also noted. The force after 24 hours dwell is noted under the column “24 hrs” and the mode of failure noted under “MOF.” The average force associated with the 24 hour dwell is also noted. The column designated as “10×” refers to reseal and repeel for 10 times. The average force is also noted.

TABLE 7
Results of 90 Degree Peel Evaluations of Samples Using A.L. Flowrap Substrate (OPP)

| | | Cross-Linker | | | | | | | | | |
|---|---|---|---|---|---|---|---|---|---|---|---|
| | | (wt. %) | CW | 15 min | MOF | AVG | 24 hr | MOF | AVG | 10 X | AVG |
| 5% | A | 0.1-0.5 | 20.8 | 1.06 | clean | 1.05 | 1.15 | clean | 1.13 | 0.73 | 0.72 |
| Trilene | | | | 1.04 | clean | | 1.10 | clean | | 0.70 | |
| CP80 | B | 0.1-0.5 | 20.3 | 0.52 | clean | 0.54 | 0.60 | clean | 0.62 | 0.36 | 0.37 |
| | | | | 0.56 | clean | | 0.64 | clean | | 0.37 | |
| | C | 0.1-0.5 | 20.2 | 0.42 | clean | 0.41 | 0.50 | clean | 0.46 | 0.25 | 0.25 |
| | | | | 0.40 | clean | | 0.41 | clean | | 0.25 | |
| | D | 0.1-0.5 | 19.8 | 0.37 | clean | 0.37 | 0.47 | clean | 0.49 | 0.23 | 0.25 |
| | | | | 0.37 | clean | | 0.50 | clean | | 0.26 | |
| 10% | E | 0.1-0.5 | 18.0 | 0.71 | lt. stain | 0.70 | 0.80 | lt. stain | 0.75 | 0.40 | 0.43 |
| Trilene | | | | 0.68 | lt. stain | | 0.70 | lt. stain | | 0.45 | |
| CP80 | F | 0.1-0.5 | 18.8 | 0.45 | clean | 0.45 | 0.53 | clean | 0.53 | 0.30 | 0.29 |
| | | | | 0.45 | clean | | 0.53 | clean | | 0.28 | |
| | G | 0.1-0.5 | 18.0 | 0.32 | lt. stain | 0.34 | 0.37 | lt. stain | 0.37 | 0.17 | 0.19 |
| | | | | 0.36 | clean | | 0.37 | lt. stain | | 0.20 | |
| | H | 0.1-0.5 | 18.9 | 0.29 | clean | 0.30 | 0.33 | clean | 0.35 | 0 | 0.20 |
| | | | | 0.31 | clean | | 0.36 | clean | | 0.20 | |
| 20% | I | 0.1-0.5 | 20.5 | 0.54 | stain | 0.49 | 0.48 | lt. stain | 0.50 | 0.38 | 0.35 |
| Trilene | | | | 0.44 | stain | | 0.51 | lt. stain | | 0.32 | |
| CP80 | J | 0.1-0.5 | 21.3 | 0.30 | stain | 0.35 | 0.35 | lt. stain | 0.40 | 0.22 | 0.23 |
| | | | | 0.40 | stain | | 0.45 | lt. stain | | 0.24 | |
| | K | 0.1-0.5 | 20.1 | 0.30 | stain | 0.31 | 0.31 | lt. stain | 0.32 | 0.17 | 0.17 |
| | | | | 0.31 | stain | | 0.32 | lt. stain | | 0.17 | |
| | L | 0.1-0.5 | 21.0 | 0.38 | lt. stain | 0.38 | 0.38 | lt. stain | 0.39 | 0.21 | 0.20 |
| | | | | 0.37 | lt. stain | | 0.39 | lt. stain | | | |

TABLE 8
Results of 90 Degree Peel Evaluations of Samples Using Matte Flowrap (PET)

| | | Cross-Linker | | | | | | | | | |
|---|---|---|---|---|---|---|---|---|---|---|---|
| | | (wt. %) | CW | 15 min | MOF | AVG | 24 hr | MOF | AVG | 10 X | AVG |
| 5% | A | 0.1-0.5 | 20.8 | 2.27 | lt. zip | 2.27 | 3.24 | major zip | 3.00 | X | |
| Trilene | | | | 2.27 | lt. zip | | 2.76 | major zip | | X | |
| CP80 | B | 0.1-0.5 | 20.3 | 1.75 | clean | 1.55 | 1.96 | clean | 1.79 | 0.97 | 0.96 |
| | | | | 1.35 | clean | | 1.62 | clean | | 0.94 | |
| | C | 0.1-0.5 | 20.2 | 1.38 | clean | 1.38 | 1.60 | clean | 1.62 | 0.85 | 0.85 |
| | | | | 1.37 | clean | | 1.63 | clean | | 0.84 | |
| | D | 0.1-0.5 | 19.8 | 0.96 | clean | 1.10 | 1.43 | clean | 1.45 | 0 | 0.39 |
| | | | | 1.23 | clean | | 1.46 | clean | | 0.77 | |
| 10% | E | 0.1-0.5 | 18.0 | 1.55 | clean | 1.52 | 1.85 | clean | 1.83 | 1.08 | 1.10 |
| Trilene | | | | 1.49 | clean | | 1.81 | clean | | 1.11 | |
| CP80 | F | 0.1-0.5 | 18.8 | 1.29 | clean | 1.30 | 1.45 | clean | 1.47 | 0.83 | 0.86 |
| | | | | 1.30 | clean | | 1.48 | clean | | 0.89 | |
| | G | 0.1-0.5 | 18.0 | 1.12 | clean | 1.14 | 1.33 | clean | 1.34 | 0.79 | 0.79 |
| | | | | 1.16 | clean | | 1.35 | clean | | 0.78 | |
| | H | 0.1-0.5 | 18.9 | 1.12 | clean | 1.15 | 1.34 | clean | 1.32 | 0.74 | 0.74 |
| | | | | 1.18 | clean | | 1.30 | clean | | 0.74 | |
| 20% | I | 0.1-0.5 | 20.5 | 1.88 | clean | 1.88 | 2.04 | clean | 2.03 | 1.14 | 1.18 |
| Trilene | | | | 1.87 | clean | | 2.01 | clean | | 1.21 | |
| CP80 | J | 0.1-0.5 | 21.3 | 1.55 | clean | 1.56 | 1.70 | clean | 1.73 | 0.85 | 0.87 |
| | | | | 1.57 | clean | | 1.75 | clean | | 0.88 | |
| | K | 0.1-0.5 | 20.1 | 1.56 | clean | 1.60 | 1.75 | clean | 1.78 | 0.86 | 0.86 |
| | | | | 1.63 | clean | | 1.81 | clean | | 0.85 | |
| | L | 0.1-0.5 | 21.0 | 1.48 | clean | 1.35 | 1.71 | clean | 1.63 | 0 | 0.70 |
| | | | | 1.22 | clean | | 1.55 | clean | | 0.70 | |

TABLE 9
Results of 90 Degree Peel Evaluations of Samples Using Gloss Flowrap (PET)

| | | Cross-Linker | | | | | | | | | |
|---|---|---|---|---|---|---|---|---|---|---|---|
| | | (wt. %) | CW | 15 min | MOF | AVG | 24 hrs | MOF | AVG | 10 X | AVG |
| 5% | A | 0.1-0.5 | 20.8 | 5.31 | split/ | 5.29 | 5.67 | split | 5.54 | X | |
| Trilene | | | | | tab slip | | | | | | |
| CP80 | | | | 5.26 | split | | 5.40 | split | | X | |
| | B | 0.1-0.5 | 20.3 | 3.06 | clean | 2.65 | 3.49 | clean | 3.16 | 0.81 | 0.96 |
| | | | | 2.23 | clean | | 2.82 | clean | | 1.10 | |
| | C | 0.1-0.5 | 20.2 | 1.82 | clean | 1.85 | 2.33 | clean | 2.33 | 1.06 | 1.48 |
| | | | | 1.87 | clean | | 2.33 | clean | | 1.90 | |
| | D | 0.1-0.5 | 19.8 | 1.42 | clean | 1.47 | 2.19 | clean | 2.19 | 0.88 | 0.88 |
| | | | | 1.52 | clean | | X | | | X | |
| 10% | E | 0.1-0.5 | 18.0 | 2.29 | clean | 2.35 | 2.80 | clean | 2.86 | 1.36 | 1.36 |
| Trilene | | | | 2.40 | clean | | 2.91 | clean | | X | |
| CP80 | F | 0.1-0.5 | 18.8 | 1.70 | clean | 1.77 | 2.19 | clean | 2.17 | 0.97 | 1.01 |
| | | | | 1.83 | clean | | 2.15 | clean | | 1.05 | |
| | G | 0.1-0.5 | 18.0 | 1.49 | clean | 1.48 | 1.80 | clean | 1.83 | 0.88 | 0.86 |
| | | | | 1.47 | clean | | 1.85 | clean | | 0.84 | |
| | H | 0.1-0.5 | 18.9 | 1.32 | clean | 1.65 | 1.73 | clean | 2.10 | 0.80 | 0.80 |
| | | | | 1.97 | clean | | 2.47 | clean | | 0.79 | |
| 20% | I | 0.1-0.5 | 20.5 | 3.41 | clean | 3.31 | 5.14 | zip/ | 4.50 | X | |
| Trilene | | | | | | | | med. tr | | | |
| CP80 | | | | 3.21 | clean | | 3.86 | zip/v. | | X | |
| | | | | | | | | lt. tr | | | |
| | J | 0.1-0.5 | 21.3 | 3.15 | clean | 3.09 | 3.43 | clean | 3.44 | 1.09 | 1.11 |
| | | | | 3.02 | clean | | 3.44 | clean | | 1.13 | |
| | K | 0.1-0.5 | 20.1 | 2.99 | clean | 2.98 | 3.74 | clean | 3.76 | 0.95 | 0.93 |
| | | | | 2.96 | clean | | 3.78 | clean | | 0.90 | |
| | L | 0.1-0.5 | 21.0 | 2.90 | clean | 3.04 | 3.93 | clean | 3.91 | 0.90 | 0.89 |
| | | | | 3.18 | clean | | 3.88 | clean | | 0.87 | |

In another series of evaluations, an adhesive sample comprising from 5 wt % to 20 wt % of liquid polyisobutylene, formulated with 0.1 wt % to 0.5 wt % cross-linker AAA (aluminum acetoacetate), and using a coat weight of 20 gsm was subjected to 90° peel testing. The results of these evaluations are set forth below in Table 10.

TABLE 10
Results of 90 Degree Peel Evaluation

| 15 min | AVG. | 24 hr | AVG. | 10x | AVG. |
|---|---|---|---|---|---|
| 1.11 | 1.04 | 1.16 | 1.32 | 0.59 | 0.61 |
| 0.97 | | 1.47 | | 0.62 | |

In another series of evaluations, adhesive samples comprising from 50 wt % to 70 wt % of polymer and from 0.1 wt % to 0.5 wt % cross-linker AAA were subjected to Williams Plasticity Index (WPI). WPI values were 2.29 and 2.27. The samples were subjected to 90° peel testing and 180° peel testing. The results are set forth below in Tables 11 and 12.

TABLE 11
Results of 90 Degree Peel Evaluation

| | | | | | | | Static |
|---|---|---|---|---|---|---|---|
| | 90° Peels 15 Min | | | 90° Peels 24 Hr | | | shear |
| CW | Glass | PP | Glass | PP | Glass | PP | 1 × 1 × 1 kg |
| 20.6 gsm | 3.4 | 0.9 | 2.0 | 0.9 | 7.5 | 1.7 | 7,431 |

TABLE 12
Results of 180 Degree Peel Evaluation

| | | | | | | | Static |
|---|---|---|---|---|---|---|---|
| | 180° Peels 15 Min | | | 180° Peels 24 Hr | | | shear |
| CW | PET | PP | PET | PP | PET | PP | 1 × 1 × 1 kg |
| 60 gsm | 4.7 | 4.7 | 4.6 | 4.7 | 11.5 | 3.2 | 465 |

In another series of evaluations, adhesive samples comprising from 50 wt % to 70 wt % of polymer and from 0.1 wt % to 0.5 wt % cross-linker AAA applied at a coatweight of 20.6 gsm corresponding to a layer thickness of 0.14 mm was subjected to 90° peel testing on glass and polypropylene (PP) panels. The results of such evaluations are set forth below in Table 13.

TABLE 13
Results of 90 Degree Peel Evaluation

| 15 Minute Dwell | | | 24 HR Dwell | | |
|---|---|---|---|---|---|
| Force | MOF | Average | Force | MOF | Average |

Peels on Glass

| | | | | | |
|---|---|---|---|---|---|
| 3.69 | CS, spotty no tr | 3.380 | 1.96 | No tr | 1.977 |
| 2.79 | No tr, spotty CS | | 1.85 | No tr | |
| 3.66 | CS, spotty no tr | | 2.12 | No tr | |

Peels on PP

| | | | | | |
|---|---|---|---|---|---|
| 0.82 | No tr | 0.933 | 0.87 | No tr | 0.947 |
| 0.87 | No tr | | 0.92 | No tr | |
| 1.11 | No tr | | 1.05 | No tr | |

The samples formulated as described in association with Table 13, were also subjected to Loop tack testing on glass and polypropylene (PP) panels. The results of these evaluations are set forth below in Table 14.

TABLE 14
Results of Loop Tack Evaluation

| Glass Loop Tack | | | PP Loop Tack | | |
|---|---|---|---|---|---|
| Force | MOF | Average | Force | MOF | Average |
| 7.17 | Mix of CS and no tr | 7.527 | 1.61 | No tr | 1.663 |
| 8.18 | Mix of CS and no tr | | 1.74 | No tr | |
| 7.23 | Mix of CS and no tr | | 1.64 | No tr | |

The samples formulated as described in association with Table 13, were also subjected to Static Shear testing. The results of these evaluations are noted below in Table 15.

TABLE 15
Results of Static Shear Evaluation
1 × 1 × 1 kg Shears

| Minutes | MOF | Average |
|---|---|---|
| 7,406.1 | Mix of 100% tr, no tr and CS | 7,431.0 |
| 7,643.7 | Mix of 100% tr, no tr and CS | |
| 7,243.1 | Mix of 100% tr, no tr and CS | |

The results of these evaluations demonstrate the excellent performance of PSAs according to the present subject matter.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

The following embodiments are contemplated. All combinations of features and embodiments are contemplated.

### Embodiment 1

A pressure sensitive adhesive composition comprising a reaction product of (i) at least one rubber component in an amount ranging from about 1 wt % to about 50 wt %, (ii) at least one (meth)acrylate monomer in an amount ranging from about 5 wt % to about 90 wt %, and (iii) at least one initiator in an amount ranging from about 0.01 wt % to about 1 wt %; wherein the at least one rubber component is selected from the group consisting of ethylene propylene diene monomer (EPDM) rubber, polyisobutylene rubber, farnesene compound, and combinations thereof.

### Embodiment 2

An embodiment of embodiment 1, wherein the pressure sensitive adhesive is free of tackifier.

### Embodiment 3

An embodiment of any of embodiments 1 or 2, wherein the at least one initiator is selected from the group consisting of a photo-initiator, a thermal initiator, a radical initiator, a free-radical initiator, and combinations thereof.

### Embodiment 4

An embodiment of any of embodiments 1-3, wherein the at least one rubber component comprises EPDM rubber, wherein the EPDM rubber is amorphous or non-crystalline.

### Embodiment 5

An embodiment of embodiment 4, wherein the EPDM rubber comprises ethylene in an amount ranging from about 20 wt % to about 70 wt %.

### Embodiment 6

An embodiment of any of embodiments 4 or 5, wherein the EPDM rubber comprises ethylene in an amount ranging from about 45 wt % to about 70 wt %, wherein the EPDM rubber has a viscosity ranging from 10 Mooney Units to 55 Mooney Units, wherein the EPDM rubber has a glass transition temperature ranging from about −40° C. to about −60° C. as dynamic mechanical analysis (DMA) method.

### Embodiment 7

An embodiment of any of embodiments 4-6, wherein the EPDM rubber comprises a non-conjugated diene is selected from the group consisting of ethylidene norbornene, 1-4-hexadiene or dicyclopentadiene, alkyldicyclopentadiene, 1,4-pentadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and combinations thereof.

### Embodiment 8

An embodiment of any of embodiments 1-7, wherein the at least one (meth)acrylate monomer is selected from the group consisting of C1 to C28 alkyl (meth)acrylate, aryl (meth)acrylate, cyclic (meth)acrylate, and combinations thereof.

### Embodiment 9

An embodiment of any of embodiments 1-8, wherein the at least one rubber component is present in an amount ranging from about 5 wt % to about 20 wt %, the at least one (meth)acrylate monomer is present in an amount ranging from about 5 wt % to about 80 wt %, and the at least one initiator is present in an amount ranging from about 0.05 wt % to about 0.5 wt %.

### Embodiment 10

An embodiment of any of embodiments 1-9, wherein the reaction product further comprises a hydrocarbon compound.

### Embodiment 11

An embodiment of embodiment 10, wherein the hydrocarbon compound is selected from the group consisting of hydrogenated liquid polyisoprene, methacrylicfunctionlized liquid isoprene rubber, maleic anhydride functionalized elastomeric ethylene copolymers, maleic anhydride functionalized polypropylenes, maleic anhydride functionalized polyethylenes, styrene-isoprene-styrene block copolymer, styrene-isoprene-butadiene-styrene block copolymer, and styrene-butadiene-styrene block copolymer, styrene-ethylene/butylene-styrene block copolymer, styrene-ethylene/propylene-styrene block copolymer, and diblock or multi-arm copolymers of ethylene and propylene, styrene-ethylene/butylene-styrene block copolymer with maleic anhydride grafted onto the rubber midblock, anionically polymerized polyisoprene rubbers, carboxyl-terminated polybutadiene, epoxidized hydroxyl terminated polybutadiene resin, hydroxy terminated polybutadiene resin, hydroxyl terminated 1, 3-butadiene homopolymer, vinyl functional polybutadiene, and combinations thereof.

### Embodiment 12

An embodiment of any of embodiments 1-11, wherein at least one of the reaction product or the hydrocarbon compound contains a reactive site.

### Embodiment 13

An embodiment of embodiment 12, wherein the reactive site is selected from the group consisting of silyl, carboxylic acid, hydroxyl, anhydride, aldehyde, ketone, acetate, acetoacetyl, isocyanato, amine, amide, imide, aziridine, epoxide, mercapto, acrylate, methacrylate, vinyl, and combinations thereof.

### Embodiment 14

An embodiment of any of embodiments 1-13, wherein at least one of the reaction product or the pressure sensitive adhesive further comprises a crosslinking agent.

### Embodiment 15

An embodiment of any of embodiments 1-14, wherein the reaction product is free of a crosslinking agent.

### Embodiment 16

An embodiment of any of embodiments 1-15, wherein the pressure sensitive adhesive free of an external crosslinking agent.

### Embodiment 17

An embodiment of any of embodiments 1-16, wherein the pressure sensitive adhesive exhibits a glass transition temperature (Tg) of from about −75° C. to about 107° C. as determined by dynamic mechanical analysis (DMA).

### Embodiment 18

An embodiment of any of embodiments 1-17, wherein the pressure sensitive adhesive exhibits a glass transition temperature (Tg) of from about −50° C. to about 25° C. as determined by dynamic mechanical analysis (DMA).

### Embodiment 19

An embodiment of any of embodiments 1-17, wherein the pressure sensitive adhesive exhibits a glass transition temperature (Tg) of from about −40° C. to about 0° C. as determined by dynamic mechanical analysis (DMA).

### Embodiment 20

An embodiment of any of embodiments 1-19, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

### Embodiment 21

An embodiment of any of embodiments 1-20, wherein the weight average molecular weight (Mw) of the pressure sensitive adhesive is within a range of from about 100,000 to 1,000,000 g/mole as determined by GPC.

### Embodiment 22

An article including: the pressure sensitive adhesive of any of embodiments 1-21 disposed on the substrate.

### Embodiment 23

An embodiment of embodiment 22, wherein the pressure sensitive adhesive is free of tackifier.

### Embodiment 24

An embodiment of any of embodiments 22 or 23, wherein the substrate comprises paper, polymeric films, and combinations thereof.

### Embodiment 25

An embodiment of any of embodiments 22-24, wherein the pressure sensitive adhesive is in the form of a layer and has a thickness ranging from about 10 to about 125 microns.

### Embodiment 26

An embodiment of any of embodiments 22-25, wherein the pressure sensitive adhesive is disposed on the substrate at a coat weight ranging from about 10 to about 50 gsm.

### Embodiment 27

An embodiment of any of embodiments 22-26, wherein the article is in the form of an adhesive tape.

### Embodiment 28

An embodiment of any of embodiments 22-27, further comprising a release liner at least partially disposed on the pressure sensitive adhesive.

### Embodiment 29

A method of forming a pressure sensitive adhesive, the method comprising combining (i) at least one rubber component, (ii) at least one (meth)acrylate monomer, (iii) at least one initiator in a liquid in a reactor; heating the reactor to a temperature ranging from about 25° C. to about 110° C. for a time period sufficient to form a polymeric product; and forming the pressure sensitive adhesive, wherein the forming step is selected from the group consisting of step A removing the liquid to thereby form the pressure sensitive adhesive, step B curing the polymeric product to thereby form the pressure sensitive adhesive, and combinations of step A and step B; wherein the at least one rubber component is selected from the group consisting of ethylene propylene diene monomer (EPDM) rubber, polyisobutylene rubber, farnesene compound, and combinations thereof.

### Embodiment 30

An embodiment of embodiment 29, wherein the liquid is selected from the group consisting of water, at least one hydrocarbon, at least one hydrocarbon solvent, and combinations thereof.

### Embodiment 31

An embodiment of any of embodiments 29 or 30, wherein heating is performed in an inert atmosphere, wherein heating is performed to a temperature ranging from about 70° C. to about 90° C.

### Embodiment 32

An embodiment of any of embodiments 29-31, wherein the forming step comprises removing the liquid to thereby form the pressure sensitive adhesive, wherein the method further comprises forming a layer of the polymeric product prior to curing.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A pressure sensitive adhesive composition comprising:
a reaction product of (i) at least one rubber component in an amount ranging from about 1 wt % to about 50 wt %, (ii) at least one (meth)acrylate monomer in an amount ranging from about 5 wt % to about 90 wt %, and (iii) at least one initiator in an amount ranging from about 0.01 wt % to about 1 wt %, based on the total weight of the pressure sensitive adhesive composition;
wherein the at least one rubber component is selected from the group consisting of ethylene propylene diene monomer (EPDM) rubber, polyisobutylene rubber, farnesene compound, and combinations thereof.

2. The pressure sensitive adhesive of claim 1, wherein the pressure sensitive adhesive is free of tackifier.

3. The pressure sensitive adhesive of claim 1, wherein the at least one initiator is selected from the group consisting of a photo-initiator, a thermal initiator, a radical initiator, a free-radical initiator, and combinations thereof.

4. The pressure sensitive adhesive of claim 1, wherein the at least one rubber component comprises EPDM rubber, wherein the EPDM rubber is amorphous or non-crystalline.

5. The pressure sensitive adhesive of claim 4, wherein the EPDM rubber comprises ethylene in an amount ranging from about 20 wt % to about 70 wt %.

6. The pressure sensitive adhesive of claim 4, wherein the EPDM rubber comprises ethylene in an amount ranging from about 45 wt % to about 70 wt %, wherein the EPDM rubber has a viscosity ranging from 10 Mooney Units to 55 Mooney Units, wherein the EPDM rubber has a glass transition temperature ranging from about −40° C. to about −60° C. as determined by dynamic mechanical analysis (DMA) method.

7. The pressure sensitive adhesive of claim 4, wherein the EPDM rubber comprises a non-conjugated diene is selected from the group consisting of ethylidene norbornene, 1-4-hexadiene or dicyclopentadiene, alkyldicyclopentadiene, 1,4-pentadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and combinations thereof.

8. The pressure sensitive adhesive of claim 1, wherein the at least one (meth)acrylate monomer is selected from the group consisting of C1 to C28 alkyl (meth)acrylate, aryl (meth)acrylate, cyclic (meth)acrylate, and combinations thereof.

9. The pressure sensitive adhesive of claim 1, wherein the at least one rubber component is present in an amount ranging from about 5 wt % to about 20 wt %, the at least one (meth)acrylate monomer is present in an amount ranging from about 5 wt % to about 80 wt %, and the at least one initiator is present in an amount ranging from about 0.05 wt % to about 0.5 wt %.

10. The pressure sensitive adhesive of claim 1, wherein the reaction product further comprises a hydrocarbon compound.

11. The pressure sensitive adhesive of claim 10, wherein the wherein the hydrocarbon compound is selected from the group consisting of hydrogenated liquid polyisoprene, methacrylicfunctionlized liquid isoprene rubber, maleic anhydride functionalized elastomeric ethylene copolymers, maleic anhydride functionalized polypropylenes, maleic anhydride functionalized polyethylenes, styrene-isoprene-styrene block copolymer, styrene-isoprene-butadiene-styrene block copolymer, and styrene-butadiene-styrene block copolymer, styrene-ethylene/butylene-styrene block copolymer, styrene-ethylene/propylene-styrene block copolymer, and diblock or multi-arm copolymers of ethylene and propylene, styrene-ethylene/butylene-styrene block copolymer with maleic anhydride grafted onto the rubber midblock, anionically polymerized polyisoprene rubbers, carboxyl-terminated polybutadiene, epoxidized hydroxyl terminated polybutadiene resin, hydroxy terminated polybutadiene resin, hydroxyl terminated 1, 3-butadiene homopolymer, vinyl functional polybutadiene, and combinations thereof.

12. The pressure sensitive adhesive of claim 10, wherein at least one of the reaction product or the hydrocarbon compound contains a reactive site.

13. The pressure sensitive adhesive of claim 12, wherein the reactive site is selected from the group consisting of silyl, carboxylic acid, hydroxyl, anhydride, aldehyde, ketone, acetate, acetoacetyl, isocyanato, amine, amide, imide, aziridine, epoxide, mercapto, acrylate, methacrylate, vinyl, and combinations thereof.

14. The pressure sensitive adhesive of claim 1, wherein at least one of the reaction product or the pressure sensitive adhesive further comprises a crosslinking agent.

15. The pressure sensitive adhesive of claim 1, wherein the reaction product is free of a crosslinking agent.

16. The pressure sensitive adhesive of claim 1, wherein the pressure sensitive adhesive is free of an external crosslinking agent.

17. The pressure sensitive adhesive of claim 1, wherein the pressure sensitive adhesive exhibits a glass transition temperature (Tg) of from about −75° C. to about 107° C. as determined by dynamic mechanical analysis (DMA).

18. The pressure sensitive adhesive of claim 1, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

19. The pressure sensitive adhesive of claim 1, wherein the weight average molecular weight (Mw) of the pressure sensitive adhesive is within a range of from about 100,000 to 1,000,000 g/mole as determined by GPC.

20. An article including:
a substrate defining a face; and
the pressure sensitive adhesive of any of claim 1 disposed on at least a portion of the face of the substrate.

21. The article of claim 20, wherein the substrate comprises paper, polymeric films, and combinations thereof.

22. The article of any of claim 20, wherein the pressure sensitive adhesive is in the form of a layer and has a thickness ranging from about 10 to about 125 microns.

23. The article of any of claim 20, wherein the pressure sensitive adhesive is disposed on the substrate at a coat weight ranging from about 10 to about 50 gsm.

24. The article of claim 20, wherein the article is in the form of an adhesive tape.

25. The article of any of claim 20, further comprising a release liner at least partially disposed on the pressure sensitive adhesive.

26. A method of forming a pressure sensitive adhesive, the method comprising:
combining (i) at least one rubber component, (ii) at least one (meth)acrylate monomer, (iii) at least one initiator in a liquid in a reactor;
heating the reactor to a temperature ranging from about 25° C. to about 110° C. for a time period sufficient to form a polymeric product; and
forming the pressure sensitive adhesive, wherein the forming step is selected from step A removing the liquid to thereby form the pressure sensitive adhesive, step B curing the polymeric product to thereby form the pressure sensitive adhesive, and combinations of step A and step B;
wherein the at least one rubber component is selected from the group consisting of ethylene propylene diene monomer (EPDM) rubber, polyisobutylene rubber, farnesene compound, and combinations thereof.

27. The method of claim 26, wherein the liquid is selected from the group consisting of water, at least one hydrocarbon, at least one hydrocarbon solvent, and combinations thereof.

28. The method of claim 26, wherein heating is performed in an inert atmosphere, wherein heating is performed to a temperature ranging from about 70° C. to about 90° C.

29. The method of claim 26, wherein the forming step comprises removing the liquid to thereby form the pressure sensitive adhesive, wherein the method further comprises forming a layer of the polymeric product prior to curing.
